(19) United States
(12) Patent Application Publication
(10) Pub. No.: US 2024/0223526 A1
(43) Pub. Date: Jul. 4, 2024

(54) METHODS AND SYSTEMS FOR AUTOMATED TRACKING AND COMMUNICATING EMOTION RATINGS OF A GROUP WITH A DYNAMIC ROSTER

(71) Applicant: SMALL SOFTWARE, LLC, Toledo, OH (US)

(72) Inventors: Tanner Clayton, Perrysburg, OH (US); Christopher Hawker, Columbus, OH (US); Nicholas Osoteo, Medina, OH (US); Anthony Stockwell, Columbus, OH (US); Peter Evans, Cape Coral, FL (US)

(21) Appl. No.: 18/402,233

(22) Filed: Jan. 2, 2024

Related U.S. Application Data
(60) Provisional application No. 63/478,358, filed on Jan. 4, 2023.

(51) Int. Cl. H04L 51/42; H04L 51/216

(52) U.S. Cl. CPC H04L 51/42; H04L 51/216

(57) ABSTRACT

Methods for accurately communicating with a dynamic group roster of individual members using a single user interface of a communication system are provided. A current content input of an updated group roster from a roster database is executed at predetermined time intervals. The roster database has a most recent, accurate version of the group roster. The current content input is compared to a preceding group roster present in the communication system. The group roster is updated based on the comparison. One or more messages are transmitted to individual group members of the group roster to elicit a response, wherein transmitted one or more messages is sent by one or more methods of communication. The successful transmission and/or delivery rate of such message is optionally determined.

### CLAIM OF PRIORITY

The present application claims the benefit of and priority to U.S. Provisional Application Ser. No. 63/478,358, filed on Jan. 4, 2023 entitled METHODS AND SYSTEMS FOR AUTOMATED TRACKING AND COMMUNICATING EMOTION RATINGS OF A GROUP WITH A DYNAMIC ROSTER, the content of which is hereby incorporate herein by reference as if set forth in its entirety.

### FIELD

The present inventive concept relates generally to electronic messaging and, more particularly, to automated tracking of emotional satisfaction of a group and communicating with the group through synchronization and validation of a group roster.

### BACKGROUND

Assessing and tracking ratings, such as a scale of emotions or satisfaction, of an intended member group can be challenging, especially where the group has rapidly evolving recipients. Problems generally arise when the “group roster” including a list of members of the group is not vetted and synchronized frequently to remove old members and add new members. This can lead to ratings not being representative of the accurate group members. Improved methods of tracking ratings of a group.

### SUMMARY

Some embodiments of the present inventive concept provide methods for monitoring the emotional rating of a group of individual members using a single user interface of a communication system. The method includes executing a current content input of an updated group roster from a roster database at predetermined time intervals. The roster includes having the most recent, accurate version of the group roster. The method further includes processing a comparison between the current content input to a preceding group roster present in the communication system. The group roster is updated based on the comparison result. Using the system, one or more messages is transmitted via the message communication component in the single user interface eliciting a response from individual group members. The communication is transmitted by one or more delivery methods. The communication system receives and stores the response from individual group members in a survey database; allocates values for responses to the surveys from individual group members; computes an overall rating of the group based on the values of its individual group members; and displays, in the single user interface, the emotional rating of the group as a whole. Thus, embodiments of the present inventive concept gather empirical data from surveys, questionnaires, and other communications from a recipient group member that is collected, aggregated, and adapted to associate and rate an emotional status or rating to that recipient group member. The emotion rating system is calculated using the empirical data and can be used to identify trends and analysis of the emotion data and may be extrapolated using statistical analysis to the group as a whole. The communication system displays the overall ratings to administrators.

In further embodiments of the present inventive concept, the communication system analyzes whether a communication has been delivered, received, and/or opened by the recipient.

In still further embodiments, the communication system may execute the searches of the group roster members identifying one or more characterizing terms. Search parameters may be generated based at least in part on user input received at the client device. The search results identify one or more groups of roster members for direct communication.

### BRIEF DESCRIPTION OF THE DRAWINGS

FIG. 1 is a block diagram illustrating an example system including a network in accordance with some embodiments of the present inventive concept.

FIG. 2 is a block diagram illustrating an example communication platform in accordance with some embodiments of the present inventive concept.

FIG. 3 is a flowchart illustrating operations in accordance with various embodiments of the present inventive concept.

FIGS. 4 through 5B are screen shots of a graphical user interface including information in accordance with embodiments of the present inventive concept.

FIGS. 6A and 6B are example reports generated in accordance with some embodiments of the present inventive concept.

FIGS. 7A and 7B are block diagrams illustrating machine learning system in accordance with some embodiments of the present inventive concept.

FIGS. 8 and 9 are flowcharts illustrating operations in accordance with various embodiments of the present inventive concept.

### DETAILED DESCRIPTION OF EMBODIMENTS

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

As will be appreciated by one of skill in the art, the inventive concept may be embodied as a method, data processing system, or computer program product. Accordingly, the present inventive concept may take the form of an entirely hardware embodiment or an embodiment combining software and hardware aspects all generally referred to herein as a “circuit” or “module.” Furthermore, the present inventive concept may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present inventive concept may be written in an object-oriented programming language such as Java®, Smalltalk or C++. However, the computer program code for carrying out operations of the present inventive concept may also be written in conventional procedural programming languages, such as the “C” programming language or in a visually oriented programming environment, such as VisualBasic or JavaFx.

The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The inventive concept is described in part below with reference to a flowchart illustration and/or block diagrams of methods, systems and computer program products according to embodiments of the inventive concept. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

As discussed in the background of the present inventive concept, assessing and tracking ratings, such as a scale of emotions or satisfaction, of an intended member group can be challenging, especially where the group has rapidly evolving recipients. Problems generally arise when the “group roster” including a list of members of the group is not vetted and synchronized frequently to remove old members and add new members. This can lead to ratings not being representative of the accurate group members.

Accordingly, some embodiments of the present inventive concept are directed to using a single user interface to assess and track ratings of individual members of a group through communications and responses from individual members that are scored to establish an overall single rating for the group. In order to accurately assess and track ratings, embodiments of the present inventive concept determine that communications are sent via the single user interface to an intended recipient group. Validation of the intended group of recipients is automated and synchronized with a computer readable medium at defined intervals. Communications may be transmitted using one or more methods of communication from the single user interface as will be discussed further below.

Business owners, managers, organizers and the like of large groups of people are continually attempting to gauge whether the groups they manage are happy or satisfied. However, determining the overall “happiness” or “satisfaction” of a group of people whose members are constantly changing is challenging. Embodiments of the present inventive concept improve current methods and systems by automating accuracy of communication with rapidly changing group rosters, eliciting responses from members of the group roster, and tracking and measuring the happiness of the group roster based on the responses.

Accurately communicating with a dynamic or rapidly changing roster of people is difficult. Some group rosters are very dynamic, changing monthly, weekly, daily or even hourly. This difficulty is substantially increased as the number of group members increases and as additional attributes for each member of the group are added, such as geographic, biographical, or temporal characteristics, for example, are added. Historically, quick service restaurants rely on personnel databases from payroll or other services to compile the most up-to-date group roster. However, these databases are not used to communicate directly with their staff. Communicating directly with a dynamic roster from a single platform would substantially reduce the amount of time needed to send out electronic communications to the group members. In addition, such a single platform that would permit communicating via one or more methods of communication would improve delivery rates to keep group members informed. Integration of roster synchronization into a single user interface would further facilitate more accurate communication among scaling rosters.

Embodiments of the present inventive concept are directed to systems and methods for tracking and assessing the “emotional” rating of a group, which includes communicating with an up-to-date, accurate roster of group members between a plurality of distributed client devices via a single user interface accessible through a communication platform. The methods and systems are configured to execute a content exchange of the group roster from a database that includes the most recent and accurate version of the group members at predetermined time intervals; transmit the group roster content to the communication network; and execute transmissions from the communication network to the group roster or subsets thereof. In some embodiments, the communication platform analyzes the success or failure of the various delivery methods of communications and provides such analytics to the client.

Selections of groups within the roster may further be achieved through user-implemented searches using one or more search parameters recognizing characteristic elements of the members. The user interface enables exchange of content with the roster of group members, or subsets thereof based on search criteria.

In some embodiments, the communication platform allows for the direct message transmission of content to a group roster. Message transmission may be conducted by any suitable electronic means including, but not limited to, Short Message Service (SMS), text messaging, instant messaging (IM), email, web form input, push notification, chat notification, Application Program Interface (API) function call and the like. The system is configured to determine information about a user's preferred device(s) or preferred interfaces for receiving messaging. The system is further configured to provide delivery and receipt information relating to each transmission.

In further embodiments, each user in the system has characteristics attributable to their role in the group. Such characteristics include, but are not limited to, human resource information, including personal identifiable information (PII), scheduling information, scheduling availability, uniform sizes, skills and training information, and the like. The system is configured to cross-reference user characteristics for communication purposes.

A used herein, a “user” refers to an individual, a group of individuals, business, organization, and the like. Users may access a group-based communication or messaging system using one or more client devices. The users may be located in geographically distributed locations, for example, different countries, different cities, different neighborhoods, different buildings, different rooms, different portions of a room, and/or the like, and the respective client devices may thus be distributed among different locations.

“Group-based” refers to a system, channel, message, or virtual environment that has security sufficient such that it is accessible only to a defined group of users. The group may be defined by common access credentials such as those of an organization or commercial enterprise. Access may further be facilitated by a validated request to join or an invitation to join transmitted by one group member user to another non-member user. Group identifiers (defined below) are used to associate data, information, messages, etc., with specific groups.

A “group roster” refers to any group of recipients. This group may include other identifiable sub-groups based on specific characteristics. It can further refer to more than one group based on the needs of the user. Groups whose members often change would benefit the most from a system in accordance with embodiments discussed herein, but this is not required. Groups of students, employees, staff, associations, organizations, and the like are contemplated by the present inventive concept. Staff members of quick service restaurants, for example, often have significant rates of turnover and hiring. As such, the staff rosters are often changing.

A “synchronized roster” refers to the most current list of recipient members of the group. In some embodiments, the user interface may interact with a database that houses the most updated version of the roster. Synchronization of the rosters between the interface and the database can be done at any defined interval, for example, hourly, nightly, every 12 hours, every 24 hours, etc. as defined by the user.

“Client device” refers to computer hardware and/or software that is/are configured to access one or more services made available by one or more servers. The server(s) may be on another computer system, in which case the client device accesses the service by way of a network. However, embodiments of the present inventive concept are not limited to this configuration, the servers may be on the same computer system. A client device may be associated with a group identification, where the group identification is an electronic indication that suggests a group (e.g., user group) that the user belongs to. Alternatively, the client device may be associated with individuals associated with a group or a subset of a group based on particular identifying characteristics. Client devices may include, without limitation, smart phones, tablet computers, laptop computers, desktop computers, wearable devices, personal computers, enterprise computers, portable electronic devices of any kind and the like.

A “communication system” or “communication platform” refers to a collection of computing services that are accessible to one or more client devices, and that are operable to provide access to a plurality of software applications related to operations of databases. In some examples, the communication platform may be provided by one or more central servers (e.g., communication servers) disposed in communication with one or more additional servers running software applications, and having access to one or more databases storing digital content items, application-related data, and/or the like. The communication platform may also support client retention settings and other compliance aspects. Further, the communication platform may provide comprehensive third party developer support that grants appropriate access to the data and allows third parties to build applications and bots to integrate with customer's workflows.

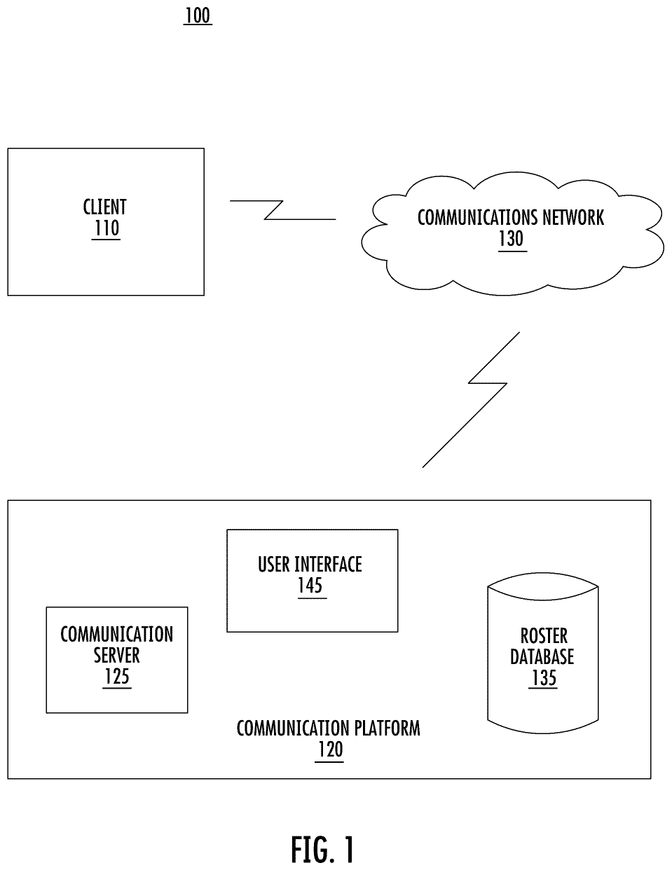

Referring first to FIG. 1, a diagram illustrating an example system 100 in which systems consistent with the principles in accordance with embodiments of the present inventive concept may be implemented. As illustrated, the system 100 includes a client 110, a communications network 130 and a communications platform 120.

The one or more client devices 110 are connected to the communication platform server 120 via a network 130. Although a single client 110 and platform 120 have been illustrated as connected to a single network 130 for simplicity, there may be more or fewer clients, servers and networks without departing from the scope of the present inventive concept. Also, in some instances, a client may perform the functions of a server and/or a server may perform the functions of a client without departing from the scope of the present inventive concept.

A client 110 may include any feasible client entity. An entity may be defined as a device, such as a personal computer, a wireless telephone, a personal digital assistant (PDA), a laptop, a tablet, wearable, or another type of computation or communication device, a thread or process running on one of these devices, and/or an object executable by one of these devices.

Electronic data may be transferred to and from the client devices 110 from the communications platform 120 in various forms and via various methods. In some embodiments of the present inventive concept, the communication platform 120 may correspond to a local server and may communicate with client 110 via a local area network. In further embodiments, the communication platform 120 may correspond to a web server and may communicate with client 110 via a wide area network (WAN), such as the Internet. In still further embodiments, the system 100 may include no server 120 and client 110 may operate as a standalone device.

As illustrated in FIG. 1, the communication platform 120 may include a communications server 125, a user interface 145, and a roster database 135. The communications server 125 may gather, process, and/or maintain documents in a manner consistent with embodiments of the present inventive concept. The communications platform 120 in FIG. 1 is provided as an example only and embodiments of the present inventive concept are not limited thereto.

The network 130 may include a wired or wireless communication network, including, for example, a wired or wireless local area network (LAN), personal area network (PAN), metropolitan area network (MAN), a wide area network (WAN), a telephone network, such as the Public Switched Telephone Network (PSTN), an intranet, the Internet, a memory device, or a combination of networks. The client 110 and the communication platform 120 may connect to network 130 via wired, wireless, and/or optical connections and communicate therethrough.

In some embodiments, the communication platform 120 may have a single user interface 145, which allows the user to transmit and exchange content with the one or more clients 110. The platform 120 includes the communication server 125, which interacts with a secondary database that possesses the most up-to-date, accurate group roster 135. The server 125 may interact with the roster database 145 on a periodic basis dictated by the user, to ensure that the roster accessible by the user interface 145 is accurate. The intervals of time may be any suitable time, including hourly, daily, weekly, etc. to ensure appropriate capture of the accurate group roster. For example, some groups' rosters change very often and others may not change very often at all. Thus, frequency with which the roster database 145 is updated may depend on the type of group and how often a roster of this group changes.

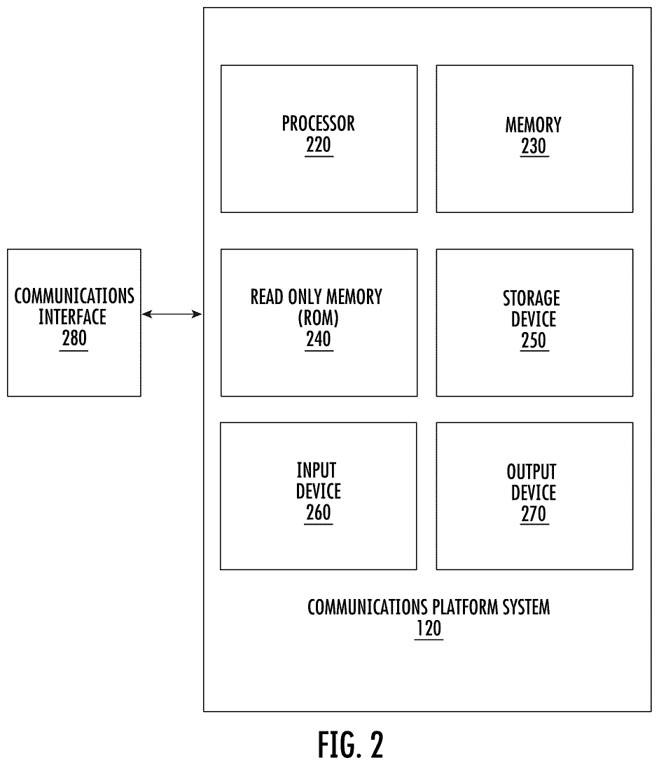

Referring now to FIG. 2, a block diagram illustrating details of an example of a data processing system corresponding to the communication platform 120 in accordance with embodiments of the present inventive concept will be discussed. It will be understood that the details of the platform in FIG. 2 are provided as an example only and embodiments of the present inventive concept are not limited thereto.

As illustrated, the data processing system of the platform 120 includes a processor 220, a main memory 230, a read only memory (ROM) 240, a storage device 250, an input device 260, an output device 270 and a communications interface 280. It will be understood that the communications interface 280 can be part of the platform 120 or separate therefrom without departing from the scope of the present inventive concept. Furthermore, the elements of the platform 120 may be expanded or combined. For example, the input device 260 and the output device 270 may be combined into a single input/output (I/O) device. The various elements, in some embodiments may be connected by a bus or other connection that allows communication among the elements of the communication platform system 120. Data from the roster database 135 may be input via the input device 260.

The processor 220 may include any type of conventional processor, microprocessor, or logic (e.g., a field programmable gate array, application specific integrated circuit, etc.) that interprets and executes instructions. The main memory 230 may include a random access memory (RAM) or another type of dynamic storage device that stores information and instructions for execution by processor 220. The ROM 240 may include a conventional ROM device or another type of static storage device that stores static information and instructions for use by processor 220. The storage device 250 may include a magnetic and/or optical recording medium and its corresponding drive.

The input device 260 may include a mechanism that permits a user, for example, administrator to input information into the communication platform system 120 using a user interface, such as a keyboard, a touch screen, voice recognition, a mouse, a pen, and the like. The output device 270 may include a mechanism that outputs information to the administrator, including a display, a printer, a speaker, etc. The communication interface 280 may include any transceiver-like mechanism that enables an external roster database 135 to communicate with other devices and/or systems. For example, communication interface 280 may include mechanisms for communicating with another device or system via a network, such as network 130.

As will be discussed in detail below, the communication platform system 120 in accordance with some embodiments of the present inventive concept may transmit content to individuals in a group roster. The group roster may be obtained by receiving information from a roster database 135 and updating the roster in the communication platform system 120. The communication platform system 120 may perform these and other operations in response to the processor 220 executing instructions contained in a computer-readable medium, such as the memory 230. A computer-readable medium may be defined as one or more memory devices and/or carrier waves. The software instructions may be read into memory 230 from another computer-readable medium, such as data storage device 250, or from another device via communication interface 280. The software instructions contained in the memory 230 may cause processor 220 to perform processes that will be discussed below. Alternatively, hardwired circuitry may be used in place of or in combination with software instructions to implement processes consistent with embodiments of the present inventive concept. Thus, systems and methods in accordance with some embodiments of the present inventive concept are not limited to any specific combination of hardware circuitry and software.

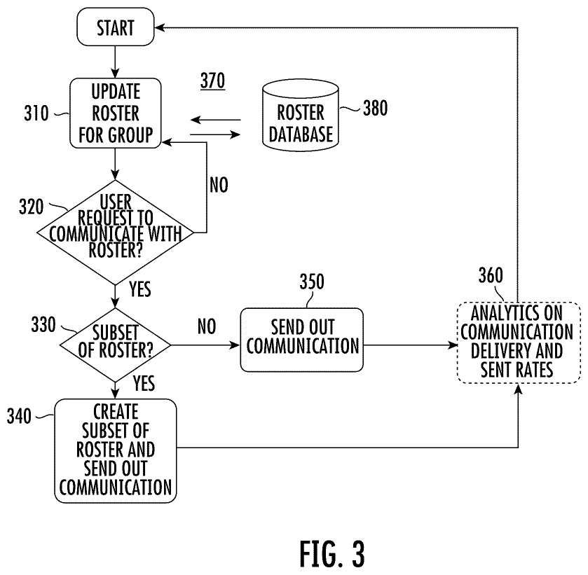

FIG. 3 is a flowchart illustrating operations for updating a roster in accordance with some embodiments of the present inventive concept. As illustrated, operations begin at block 310 by updating a roster for the group responsive to a request from a user to communicate 370 with the roster database 380 (block 320). The updated roster may be compared to the current roster in the communication platform server 120 to the updated roster in the roster database 380. For example, this can be conducted by generating source code that matches at least a part of the current roster in the communication server with the data in the roster database, compiling the source code into binary code, and determining matches between the current roster and the updated roster in the roster database. Any data relating to the individuals in the group rosters may be matched according to this method, including changes in the characteristics of individuals.

Using, for example, a user interface, the user may request to communicate 320 using the full roster in the communication server 120. Alternatively, the user may request a subset of the roster (block 330) based on one or more search parameters set by the user. A subset of the roster is a set including less than all the members of the roster. The search parameters may include search terms based on the characteristics set forth in the data relating to each rostered member. For example, in an employee database, the search terms may include such characteristics as title, location, geographic distance from a prescribed location, work status, and the like. For students, the characteristics may be student identification (ID) number, location, residence, year, etc. Any number of characteristics may be used to determine subsets of users. If it is determined that the subset is requested (block 330) operations proceed to block 350 where the subset is communicated. If, on the other hand, it is determined that a full roster is requested (block 340) operations proceed to block 360 for processing as will be discussed below.

Delivery of content through the communications platform system 120 may be conducted via one or more methods to the intended recipient. For example, the communication may be delivered via email, text, or SMS messaging, API functional call, bulletin boards or chats on mobile apps, other message communications on mobile apps or web-based apps, direct messages on mobile apps or web-based apps, etc. In some embodiments, the user interface allows the user to define how messages are sent and allows messages to differ from each other based on the delivery method. More than one method of delivery may be selected.

The type of content transmitted via the communication platform 120 is not limited. Any form of communication is contemplated herein, including but not limited to, texts, links, hyperlinks, attachments, pictures, and video.

Referring again to the flowchart of FIG. 3, analytics of communications may be provided that are set forth in the user interface (block 360). Numerous attributes may be included in the analytics relating to communications. For example, the communication platform system 120 may provide information relating to communications sent, delivered, received, etc. Such analytics include, but are not limited to, delivery rates, number of intended recipients, number of actual recipients, the basis for non-delivery including bad information relating to email addresses or phone numbers, number of emails sent, number of SMS or text messages sent, etc. In addition, graphical representations of analytics may be implemented to quickly deliver the relevant information in an easy-to-read manner.

In some embodiments, the communication platform 120 may identify the most effective method of communicating with a particular individual. The system allows the users to see the delivery rates of each individual recipient based on the delivery method, the efficiency rate of the delivery, the last successful method of delivery, and the ability for an individual to receive deliveries via certain methods, e.g., via mobile app, email, or text. Based on this information, the system may assess the most probable method of delivery for each individual recipient and set that method as the default for that individual. For example, if a recipient does not respond via text or email, but has the mobile application, the system may determine that this is the best method of delivery and set mobile application delivery as the individual's best method of communication. On the other hand, if a user on the system does not have the mobile application, but is receiving text messages, the system may be programmed to default to text messaging.

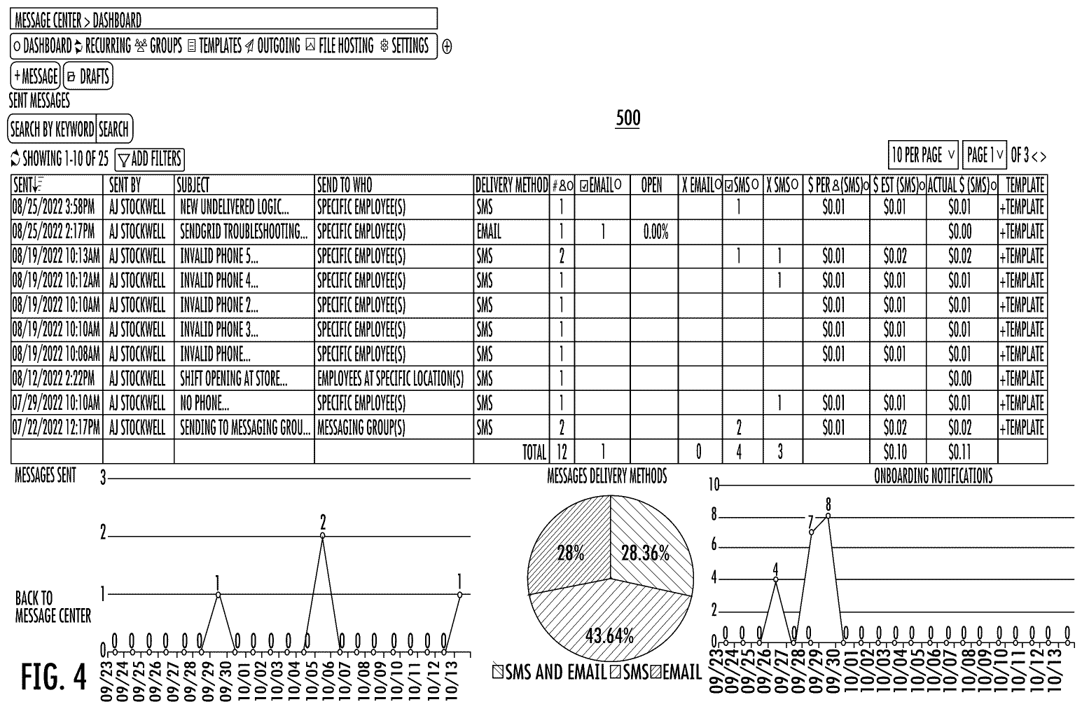

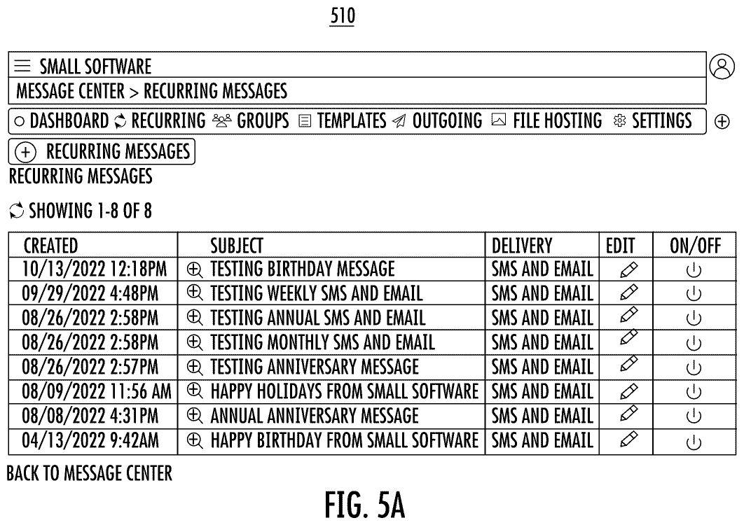

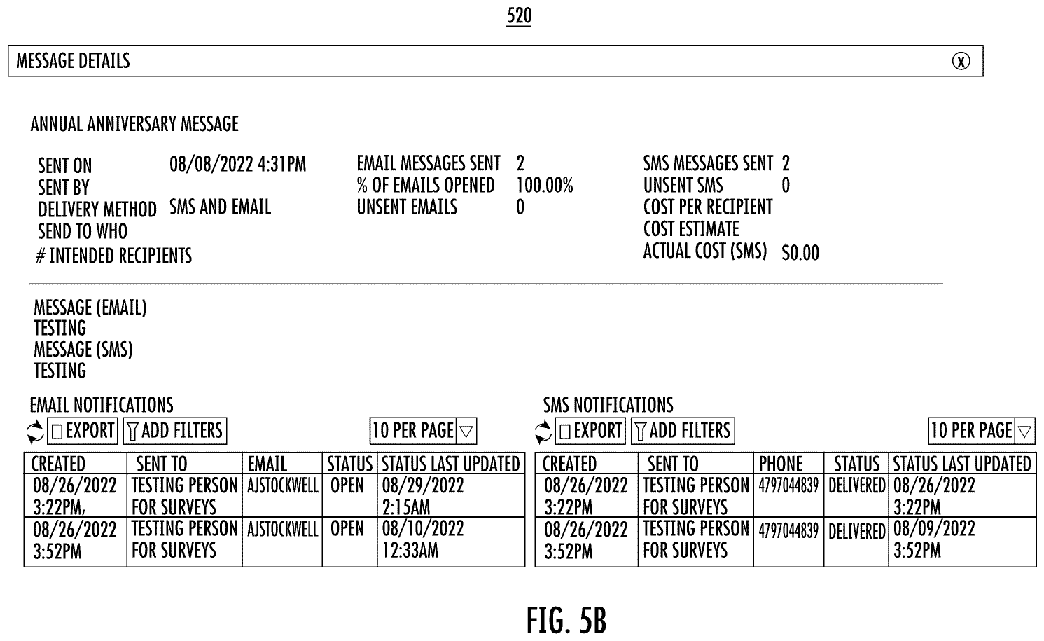

Referring now to FIGS. 4A through 5B, screen shots of an exemplary graphical user interface (GUI) that may be used in accordance with embodiments of the present inventive concept will be discussed. As illustrated, the user interface may convey the user who sent a communication, the subject line, to whom the communication was sent, delivery method, and the like, as represented in user interface 500. In addition, analytics relating to how the communication was transmitted, including the number of emails, SMS messages, number of recipients, delivery rates, etc. may be provided.

The communication platform allows the user to prepare precomposed messages and configure those messages to be transmitted upon the achievement of a determining characteristics by a member of the group roster. FIG. 5A illustrates an example screen shot of a GUI 510 that shows precomposed messages, for example, messages that are drafted in advance of being sent that will be sent out once a member of the group roster achieves a certain characteristic. Achievement of a characteristic may be based on any suitable characteristic. For example, the characteristic may be a date achieved by the member, such as a birthdate or an anniversary date (e.g., achieving a date based on a start date, entry date, or other suitable date). Alternatively, it may be predetermined based on a specific date (e.g., holiday). Other suitable characteristics may be performance based, such as achievement of a skill, fulfillment of a training, acquisition of a position, or acquisition of a title. Other characteristics are determined based on the administrator of the group and the desired objectives. Such precomposed messages may be sent via the platform at any interval. By way of example, the precomposed messages may be recurring, may occur only once for each group member, may be sent multiple times until achievement of a characteristic is met, or in any manner set by the user.

FIG. 5B illustrates a screen shot of an example GUI 520. Any type of content may be provided including messages that are for read only and those that elicit or request a response. For example, the precomposed messages may be surveys. Surveys may be sent out based on reaching an anniversary date, such as 7 days, 14 days, 30 days, 2 months, 3 months, etc., from a particular start date. The start date can be a group member's date that they started in the group, e.g., a hiring date in a company, date of admission, date of entry, etc. Surveys may be sent to by one or more methods of delivery.

Surveys and messages that elicit a response may be utilized to assess and track the emotional rating of each individual group member as well as the group. Such groups may be further limited based any characteristic, such as title, date of hire, date of birth, date of joining the group, etc. The surveys may be conducted in any various manner, including free response, multiple choice, ordinal scale, interval scale, and ratio scale. Responses to the surveys are assigned a value and may be weighted based on the questions being asked. The values may then be statistically analyzed and computed to obtain an overall score or rating for the group. Any suitable statistical method may be used to analyze the responses and datasets. Trends of the ratings as well as percentage or number of responses may further be tracked and communicated via the single user interface to allow administrators to reflect on the overall ratings by the group and each individual. Using this information, administrators will have a better understanding on the happiness and satisfaction of its group members, which can inform their decisions on whether improvements are required to increase the ratings.

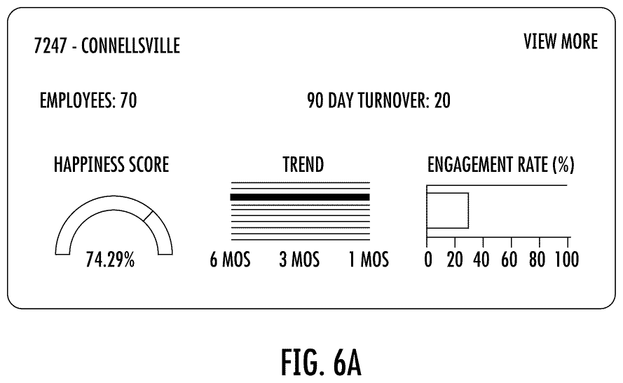

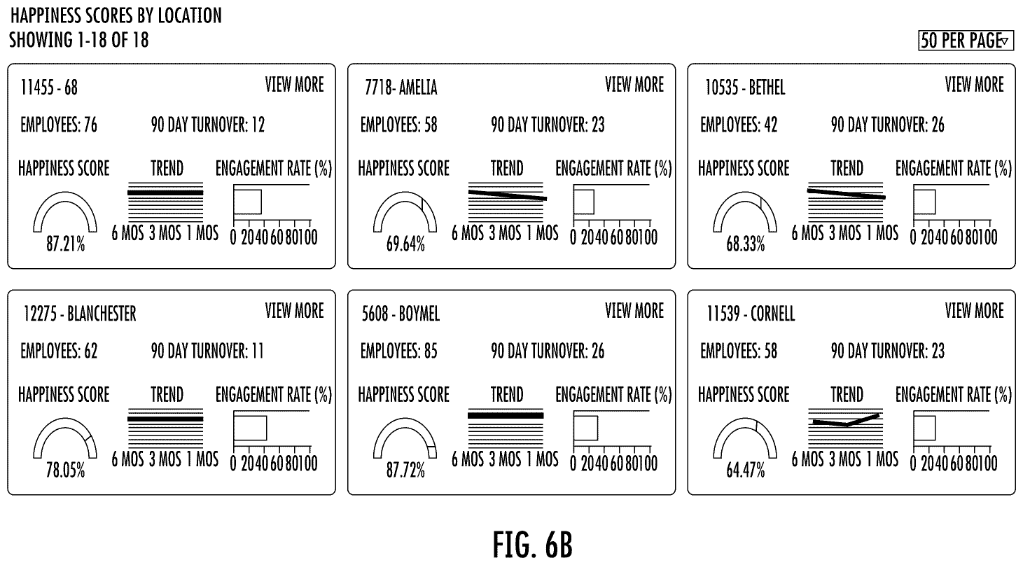

FIG. 6A illustrates an example report on the rating for an individual location, providing information such as the Happiness Score for that location, the number of employees, the 90 Day Turnover (which is frequently used to measure whether employees are happy in their job at that location), trends, and engagement rate. FIG. 6B provides an illustration of multiple locations owned by a single administrator. It will be understood that FIGS. 6A and 6B are provided as examples only and do not limit embodiments of the present inventive concept.

In addition, the communication system in accordance with embodiments of the present inventive concept may be configured to permit documents to be stored in the user interface for delivery via the communication platform or storage with a user's profile. These documents may be accessible via the platform and can be accessed by administrators.

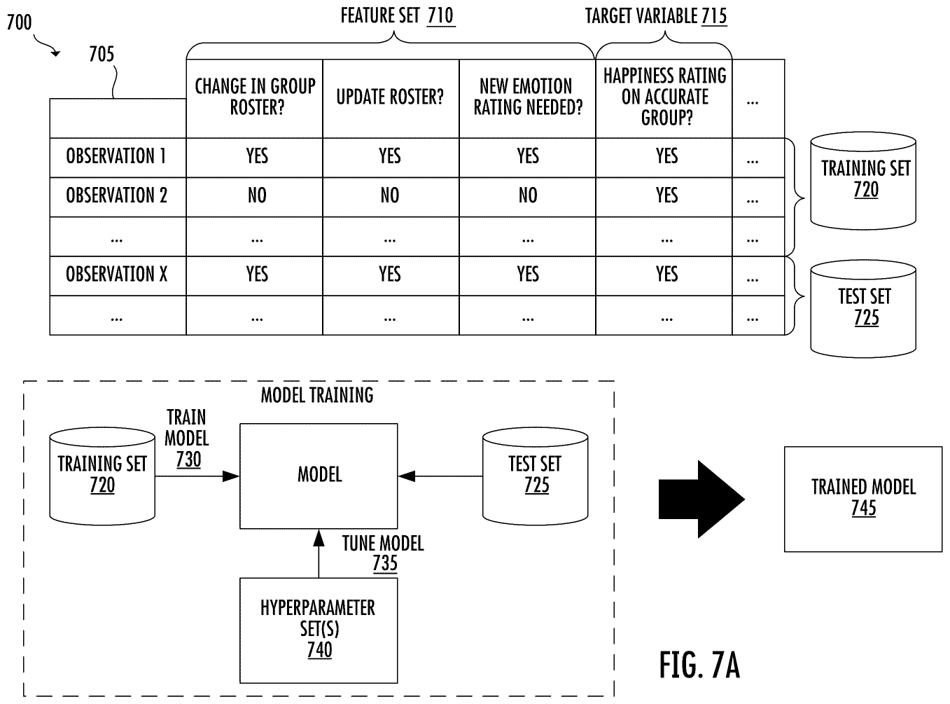

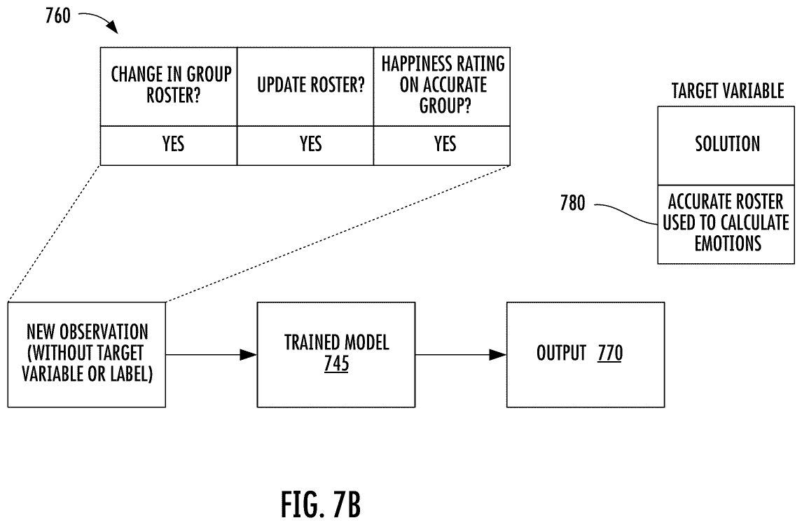

Referring now to FIGS. 7A and 7B, embodiments of the present inventive concept implemented using machine learning will now be discussed. In particular, one or more portions of the system/method discussed herein can include any various machine learning techniques, such as supervised machine learning and/or unsupervised machine learning. For example, a supervised machine learning approach can be used to train a neural network to identify data that may indicate a change in a group roster, a change in an overall group emotion, an upward or downward trend in a happiness score, a change or shift in engagement rate and the like.

Referring to FIG. 7A, a diagram illustrating an example of training a machine learning model 700 in connection with some embodiments of the present inventive concept will be discussed. The machine learning model training described herein may be performed using a machine learning system. The machine learning system may include or may be included in a computing device, a server, a cloud computing environment, or the like, such as the communication platform 120 discussed herein.

As shown by reference number 705, a machine learning model may be trained using a set of observations. The set of observations may be obtained and/or input from historical data or real time data, such as data gathered during one or more processes described herein. For example, the set of observations may include data gathered by the communication platform 120 about groups, group rosters and the emotions of the groups in a target environment, as described elsewhere herein. In some implementations, the machine learning system may receive the set of observations (e.g., as input) from the communications platform 120 or from a storage device.

As shown by reference number 710, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values.

In some implementations, the machine learning system may determine variables for a set of observations and/or variable values for a specific observation based on input received from the communication platform 120. For example, the machine learning system may identify a feature set (e.g., one or more features and/or corresponding feature values) from structured data input to the machine learning system, such as by extracting data from a particular column of a table, extracting data from a particular field of a form and/or a message, and/or extracting data received in a structured data format. Additionally, or alternatively, the machine learning system may receive input from an operator to determine features and/or feature values.

In some implementations, the machine learning system may perform natural language processing and/or another feature identification technique to extract features (e.g., variables) and/or feature values (e.g., variable values) from text (e.g., unstructured data) input to the machine learning system, such as by identifying keywords and/or values associated with those keywords from the text.

As an example, a feature set for a set of observations may include a first feature of a change in a group roster, a second feature of update roster, a third feature of new emotion rating needed, and so on. As shown, for a first observation, the first feature may have a value of “yes,” the second feature may have a value of “no,” the third feature may have a value of “Yes,” and so on. These features and feature values are provided as examples and may differ in other examples. For example, the feature set may include one or more of the following features: number of people in the group, average turn over of group members, trend of happiness score, subgroups, queries and the like. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources and/or memory resources) used to train the machine learning model.

The set of observations may be associated with a target variable 715. The target variable 715 may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 1, True or False, Yes or No, Male or Female), among other examples. A target variable may be associated with a target variable value, and a target variable value may be specific to an observation. In some cases, different observations may be associated with different target variable values. In example 700, the target variable 715 is a determination of whether the happiness score was calculated with an accurate group roster, which has a value of “Yes” for the first observation. The feature set and target variable described above are provided as examples, and other examples may differ from what is described above.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model or a predictive model. When the target variable is associated with continuous target variable values (e.g., a range of numbers), the machine learning model may employ a regression technique. When the target variable is associated with categorical target variable values (e.g., classes or labels), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, or an automated signal extraction model. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 720 that includes a first subset of observations of the set of observations, and a test set 725 that includes a second subset of observations of the set of observations. The training set 720 may be used to train (e.g., fit or tune) the machine learning model, while the test set 725 may be used to evaluate a machine learning model that is trained using the training set 720. For example, for supervised learning, the test set 725 may be used for initial model training using the first subset of observations, and the test set 725 may be used to test whether the trained model accurately predicts target variables in the second subset of observations. In some implementations, the machine learning system may partition the set of observations into the training set 720 and the test set 725 by including a first portion or a first percentage of the set of observations in the training set 720 (e.g., 75%, 80%, or 85%, among other examples) and including a second portion or a second percentage of the set of observations in the test set 725 (e.g., 25%, 20%, or 15%, among other examples). In some implementations, the machine learning system may randomly select observations to be included in the training set 720 and/or the test set 725.

As shown by reference number 730, the machine learning system may train a machine learning model using the training set 720. This training may include executing, by the machine learning system, a machine learning algorithm to determine a set of model parameters based on the training set 720. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the training set 720). For example, for a regression algorithm, a model parameter may include a regression coefficient (e.g., a weight). For a decision tree algorithm, a model parameter may include a decision tree split location, as an example.

As shown by reference number 735, the machine learning system may use one or more hyperparameter sets 740 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the machine learning model to the training set 720. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train a machine learning model, the machine learning system may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 720. The machine learning system may tune each machine learning algorithm using one or more hyperparameter sets 740 (e.g., based on operator input that identifies hyperparameter sets 740 to be used and/or based on randomly generating hyperparameter values). The machine learning system may train a particular machine learning model using a specific machine learning algorithm and a corresponding hyperparameter set 740. In some implementations, the machine learning system may train multiple machine learning models to generate a set of model parameters for each machine learning model, where each machine learning model corresponds to a different combination of a machine learning algorithm and a hyperparameter set 740 for that machine learning algorithm.

In some implementations, the machine learning system may perform cross-validation when training a machine learning model. Cross validation can be used to obtain a reliable estimate of machine learning model performance using only the training set 720, and without using the test set 725, such as by splitting the training set 720 into a number of groups (e.g., based on operator input that identifies the number of groups and/or based on randomly selecting a number of groups) and using those groups to estimate model performance. For example, using k-fold cross-validation, observations in the training set 720 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k−1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, or a standard error across cross-validation scores.

In some implementations, the machine learning system may perform cross-validation when training a machine learning model by splitting the training set into a number of groups (e.g., based on operator input that identifies the number of groups and/or based on randomly selecting a number of groups). The machine learning system may perform multiple training procedures and may generate a cross-validation score for each training procedure. The machine learning system may generate an overall cross-validation score for each hyperparameter set 740 associated with a particular machine learning algorithm. The machine learning system may compare the overall cross-validation scores for different hyperparameter sets 740 associated with the particular machine learning algorithm, and may select the hyperparameter set 740 with the best (e.g., highest accuracy, lowest error, or closest to a desired threshold) overall cross-validation score for training the machine learning model. The machine learning system may then train the machine learning model using the selected hyperparameter set 740, without cross-validation (e.g., using all of data in the training set 720 without any hold-out groups), to generate a single machine learning model for a particular machine learning algorithm. The machine learning system may then test this machine learning model using the test set 725 to generate a performance score, such as a mean squared error (e.g., for regression), a mean absolute error (e.g., for regression), or an area under receiver operating characteristic curve (e.g., for classification). If the machine learning model performs adequately (e.g., with a performance score that satisfies a threshold), then the machine learning system may store that machine learning model as a trained machine learning model 745 to be used to analyze new observations, as described below in connection with FIG. 7B.

In some implementations, the machine learning system may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 720 (e.g., without cross-validation), and may test each machine learning model using the test set 725 to generate a corresponding performance score for each machine learning model. The machine learning model may compare the performance scores for each machine learning model, and may select the machine learning model with the best (e.g., highest accuracy, lowest error, or closest to a desired threshold) performance score as the trained machine learning model 745.

As indicated above, FIG. 7A is provided as an example. Other examples may differ from what is described in connection with FIG. 7A. For example, the machine learning model may be trained using a different process than what is described in connection with FIG. 7A. Additionally, or alternatively, the machine learning model may employ a different machine learning algorithm than what is described in connection with FIG. 7A, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

FIG. 7B is a diagram illustrating an example of applying a trained machine learning model to a new observation associated with identifying anomalies and solutions in an environment. The new observation may be input to a machine learning system that stores a trained machine learning model 745, such as the trained machine learning model 745 described above in connection with FIG. 7A. The machine learning system may include or may be included in a computing device, a server, or a cloud computing environment, such the security module 240.

As shown by reference number 760, the machine learning system may receive a new observation (or a set of new observations), and may input the new observation to the machine learning model. As shown, the new observation may include a first feature of “change in group roster?,” a second feature of “update roster?,” a third feature of “happiness rating on accurate group,” and so on, as an example. The machine learning system may apply the trained machine learning model 745 to the new observation to generate an output 770 (e.g., a result). The type of output may depend on the type of machine learning model and/or the type of machine learning task being performed. For example, the output 770 may include a predicted (e.g., estimated) value of target variable (e.g., a value within a continuous range of values, a discrete value, a label, a class, or a classification), such as when supervised learning is employed. Additionally, or alternatively, the output 770 may include information that identifies a cluster to which the new observation belongs and/or information that indicates a degree of similarity between the new observation and one or more prior observations (e.g., which may have previously been new observations input to the machine learning model and/or observations used to train the machine learning model), such as when unsupervised learning is employed.

In some implementations, the trained machine learning model 745 may predict a value of “accurate roster used to calculate emotion” for the target variable of solution for the new observation, as shown by reference number 780. Based on this prediction (e.g., based on the value having a particular label or classification or based on the value satisfying or failing to satisfy a threshold), the machine learning system may provide a recommendation and/or output for determination of a recommendation. Additionally, or alternatively, the machine learning system may perform an automated action and/or may cause an automated action to be performed (e.g., by instructing another device to perform the automated action). As another example, if the machine learning system were to predict a value of “unknown” or similar for the target variable of solution, then the machine learning system may provide a different recommendation (e.g., “manually check asset”) and/or may perform or cause performance of a different automated action (e.g., reboot asset). In some implementations, the recommendation and/or the automated action may be based on the target variable value having a particular label (e.g., classification or categorization) and/or may be based on whether the target variable value satisfies one or more threshold (e.g., whether the target variable value is greater than a threshold, is less than a threshold, is equal to a threshold, or falls within a range of threshold values).

In this way, the machine learning system may apply a rigorous and automated process to determine asset vulnerabilities and the solutions thereto. The machine learning system enables recognition and/or identification of tens, hundreds, thousands, or millions of features and/or feature values for tens, hundreds, thousands, or millions of observations, thereby increasing accuracy and consistency and reducing delay associated with breach identification to the required resources (e.g., computing or manual) to be allocated for tens, hundreds, or thousands of operators to manually determine the vulnerabilities in the system.

As indicated above, FIG. 7B is provided as an example. Other examples may differ from what is described in connection with FIG. 7B.

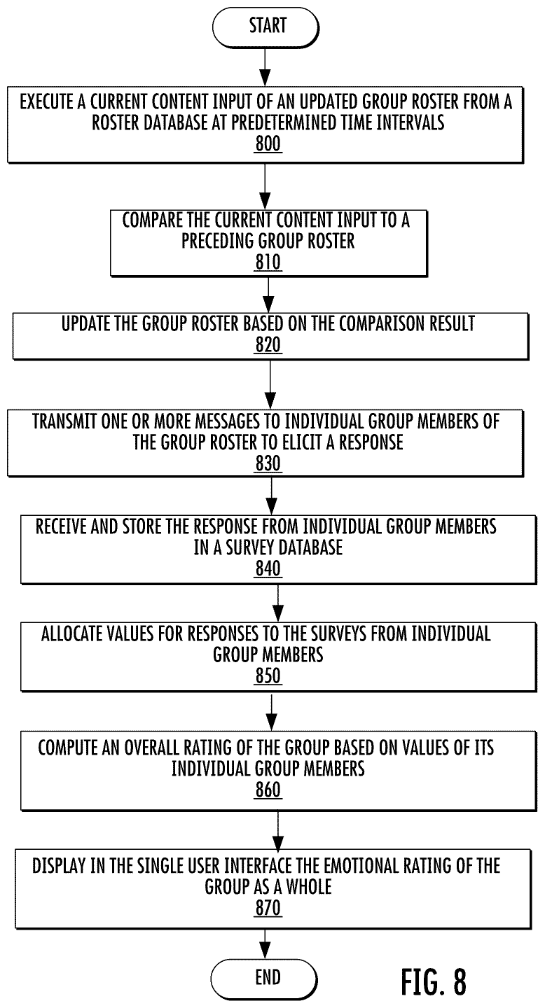

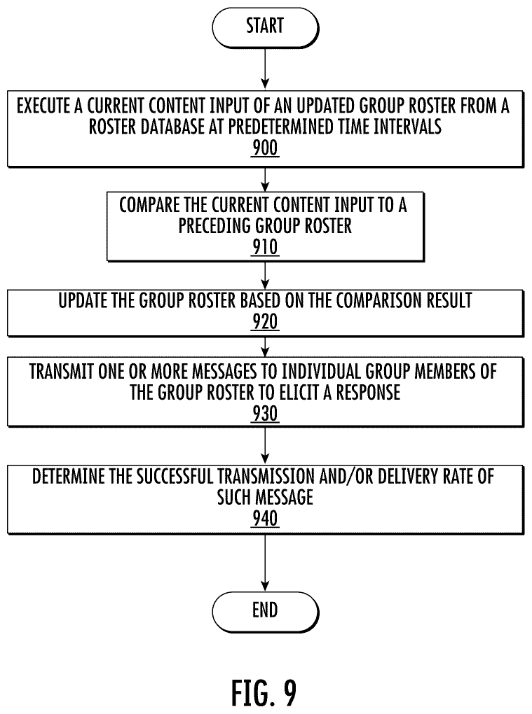

Referring now to FIGS. 8 and 9, flowcharts illustrating example methods in accordance with some embodiments of the present inventive concept will be discussed. As illustrated in FIG. 8, operations for monitoring an emotional rating of a group of individual members using a single user interface of a communication system begin at block 800 by executing a current content input of an updated group roster from a roster database at predetermined time intervals. The roster database includes a most recent, accurate version of the group roster. The current content input is compared to a preceding group roster present in the communication system to provide a comparison result (block 810). The group roster is updated based on the comparison result (block 820). One or more messages is transmitted to individual group members of the group roster to elicit a response (block 830). The one or more transmitted messages are sent by one or more methods of communication. The response from individual group members is received and stored in a survey database (block 840). The values for responses to the surveys are allocated from individual group members (block 850). An overall rating of the group is computed based on values of its individual group members (block 860). The emotional rating of the group as a whole is displayed in the single user interface (block 870).

In some embodiments, the method further includes optionally receiving, via the user interface, a request for selecting members matching characteristics to form a subset of the group roster; identifying members with the matching characteristics to form a subset of the group roster; and displaying in the user interface the members with the matching characteristics.

In further embodiments, the method may further include executing transmission of the message from the communication system to the subset of the group roster. The subset of the group roster may have one or more matching characteristics.

The message may be transmitted via one of more of the following methods: Short Message Service (SMS), text messaging, instant messaging (IM), email, web form input, push notification, chat notification, or Application Program Interface (API) function call.

The user interface provides analytics of transmission rates for each message sent. The predetermined time interval may be hourly, daily, nightly, weekly, monthly, or annually.

In some embodiments, the communication system may automatically transmit precomposed messages to a roster group or subset thereof based on a selected characteristics, wherein such transmission is executed upon a group member achieving the selected characteristic. The precomposed message may be sent based on a date characteristic associated with a group member.

A date characteristic may be one of a birthday, an anniversary day and a start date. The precomposed message may be sent based on acquisition of a performance based characteristic. The performance based characteristic may be achievement of a skill, fulfillment of a training, acquisition of a position, or acquisition of a title. The message may be a survey. The survey may be sent via text message, SMS, email, or API function call. The precomposed message may be sent based on the date. The computing of the overall rating of the group may be calculated by averaging or weighted averaging of the values. The computing may be done through statistical analysis.

Referring now to FIG. 9, operations for accurately communicating with a dynamic group roster of individual members using a single user interface of a communication system begin at block 900 by executing a current content input of an updated group roster from a roster database at predetermined time intervals. The roster database has a most recent, accurate version of the group roster. The current content input is compared to a preceding group roster present in the communication system to provide a comparison result (block 910). The group roster based is updated on the comparison result (block 920). One or more messages are transmitted to individual group members of the group roster to elicit a response (block 930). The successful transmission and/or delivery rate of such message is determined (block 940).

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Further, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Further, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C #, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Nonvolatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction.

It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

That which is claimed is:

1. A method for monitoring an emotional rating of a group of individual members using a single user interface of a communication system, the method comprising:
executing a current content input of an updated group roster from a roster database at predetermined time intervals, wherein the roster database includes a most recent, accurate version of the group roster,
comparing the current content input to a preceding group roster present in the communication system to provide a comparison result;
updating the group roster based on the comparison result;
transmitting, at a message communication component in the single user interface, one or more messages to individual group members of the group roster to elicit a response, wherein the transmitted one or more messages are sent by one or more methods of communication;
receiving and storing the response from individual group members in a survey database;
allocating values for responses to the surveys from individual group members;
computing an overall rating of the group based on values of its individual group members; and
displaying in the single user interface the emotional rating of the group as a whole.

2. The method of claim 1, further comprising:
optionally receiving, via the user interface, a request for selecting members matching characteristics to form a subset of the group roster;
identifying members with the matching characteristics to form a subset of the group roster; and
displaying in the user interface the members with the matching characteristics.

3. The method of claim 2, further comprising executing transmission of the message from the communication system to the subset of the group roster.

4. The method of claim 2, wherein the subset of the group roster has one or more matching characteristics.

5. The method of claim 1, wherein the message is transmitted via one of more of the following methods: Short Message Service (SMS), text messaging, instant messaging (IM), email, web form input, push notification, chat notification, or Application Program Interface (API) function call.

6. The method of claim 5, wherein the message is transmitted via SMS, email, and API function call.

7. The method of claim 1, wherein the user interface provides analytics of transmission rates for each message sent.

8. The method of claim 1, wherein the predetermined time interval is hourly, daily, nightly, weekly, monthly, or annually.

9. The method of claim 8, wherein the predetermined time interval is daily.

10. The method of claim 1, wherein the communication system is configured to automatically transmit precomposed messages to a roster group or subset thereof based on a selected characteristics, wherein such transmission is executed upon a group member achieving the selected characteristic.

11. The method of claim 10, wherein the precomposed message is sent based on a date characteristic associated with a group member.

12. The method of claim 11, wherein a date characteristic is one of a birthday, an anniversary day and a start date.

13. The method of claim 10, wherein the precomposed message is sent based on acquisition of a performance based characteristic.

14. The method of claim 13, wherein the performance based characteristic is achievement of a skill, fulfillment of a training, acquisition of a position, or acquisition of a title.

15. The method of claim 10, wherein the message is a survey.

16. The method of claim 15, wherein the survey is sent via text message, SMS, email, or API function call.

17. The method of claim 10, wherein the precomposed message is sent based on the date.

18. The method of claim 1, wherein the computing of the overall rating of the group is calculated by averaging or weighted averaging of the values.

19. The method of claim 1, wherein the computing is through statistical analysis.

20. A method for accurately communicating with a dynamic group roster of individual members using a single user interface of a communication system, the method comprising:
executing a current content input of an updated group roster from a roster database at predetermined time intervals, wherein the roster database has a most recent, accurate version of the group roster;
comparing the current content input to a preceding group roster present in the communication system to provide a comparison result;
updating the group roster based on the comparison result;
transmitting, at a message communication component in the single user interface, one or more messages to individual group members of the group roster to elicit a response, wherein transmitted one or more messages is sent by one or more methods of communication; and
determining the successful transmission and/or delivery rate of such message.
